(19) United States
(12) Patent Application Publication
(10) Pub. No.: US 2019/0012459 A1
(43) Pub. Date: Jan. 10, 2019

(54) RANSOMWARE DETECTION APPARATUS AND OPERATING METHOD THEREOF

(71) Applicant: Electronics and Telecommunications Research Institute, Daejeon (KR)

(72) Inventors: Doo Ho CHOI, Cheonan-si (KR); Ik Kyun KIM, Daejeon (KR); Jonghyun KIM, Daejeon (KR); Taesung KIM, Daejeon (KR); Seung Hun JIN, Daejeon (KR)

(73) Assignee: Electronics and Telecommunications Research Institute, Daejeon (KR)

(21) Appl. No.: 15/963,906

(22) Filed: Apr. 26, 2018

(30) Foreign Application Priority Data
Jul. 10, 2017 (KR) 10-2017-0087327
Apr. 24, 2018 (KR) 10-2018-0047591

(51) Int. Cl. G06F 21/56; G06F 21/55; H04L 29/06

(52) U.S. Cl. CPC G06F 21/566; H04L 63/1416; G06F 21/568; G06F 21/554

(57) ABSTRACT

A ransomware detection apparatus and an operation method thereof are provided. The ransomware detection apparatus may include a frequency converter receiving an OP code currently being executed in a CPU and converting a value of the OP code into a frequency domain to generate a first OP code frequency waveform, a memory storing a second OP code frequency waveform, which is a value obtained by converting the OP code corresponding to a ransomware encryption algorithm into a frequency domain, and a ransomware determiner comparing the first OP code frequency waveform with the second OP code frequency waveform to determine whether ransomware operates.

### CROSS-REFERENCE TO RELATED APPLICATION

This application claims priority to and the benefit of Korean Patent Application Nos. 10-2017-0087327, and 10-2018-0047591 filed in the Korean Intellectual Property Office on Jul. 10, 2017, and Apr. 24, 2018, the entire contents of which are incorporated herein by reference.

### BACKGROUND OF THE INVENTION

### (a) Field of the Invention

The present invention relates to a ransomware detection apparatus and an operation method thereof.

### (b) Description of the Related Art

Ransomware is a malicious program that encrypts data of a user in a computer system and then requests money and has made trouble recently. Ransomware has penetrated a computer of the user in various ways as well as via e-mail, and its severity is increasing

However, there is no method of blocking ransomware by detecting whether the computer system has been infected by ransomware in advance or recognizing whether ransomware encrypts data in real time. After the data has been encrypted by ransomware once, since it is impossible to recover the data, and it causes much more damage than other malicious codes.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and method for detecting ransomware in real time or at the initial stage of encryption.

According to an embodiment of the present invention, a ransomware detection apparatus may include a frequency converter receiving an OP code currently being executed in a CPU and converting a value of the OP code into a frequency domain to generate a first OP code frequency waveform, a memory storing a second OP code frequency waveform, which is a value obtained by converting the OP code corresponding to a ransomware encryption algorithm into a frequency domain, and a ransomware determiner comparing the first OP code frequency waveform with the second OP code frequency waveform to determine whether ransomware operates.

The ransomware detection apparatus may further include an OP code decoder receiving a processor tracer packet corresponding to a calculation code from the CPU and decoding the processor trace packet into the calculation code, and then outputting the decoded calculation code to the frequency converter.

The ransomware determiner may calculate a degree of similarity between the first OP code frequency waveform and the second OP code frequency waveform and determine that ransomware operates when the degree of similarity exceeds a predetermined reference value.

The ransomware determiner may compare main frequencies between the first OP code frequency waveform and the second OP code frequency waveform and calculate a correlation coefficient to calculate the degree of similarity.

When the ransomware determiner determines that ransomware operates, the ransomware determiner may store the code currently being executed in the CPU in a recovery storage device.

When the ransomware determiner determines that ransomware operates, the ransomware determiner may request the CPU to stop a corresponding process.

The frequency converter may perform an FFT (Fast Fourier Transform) on the value of the OP code to generate the first OP code frequency waveform.

The value of the OP code may be a decimal number.

According to another embodiment of the present invention, a method of operating a ransomware detection apparatus that detects whether ransomware operates in a computer system comprising a CPU may include receiving a PT (processor tracer) packet currently being executed from the CPU, decoding the PT packet into an OP code (operation code), converting a value of the OP code into a frequency domain to generate a first OP code frequency waveform, storing a second OP code frequency waveform, which is a value obtained by converting the OP code corresponding to a ransomware encryption algorithm into a frequency domain, and comparing the first OP code frequency waveform with the second OP code frequency waveform to determine whether ransomware operates.

The determining may include calculating a degree of similarity between the first OP code frequency waveform and the second OP code frequency waveform, and determining that ransomware operates through the degree of similarity.

The method may further include when it is determined in the determining that ransomware operates, storing the code currently being executed in the CPU.

The method may further include when it is determined in the determining that ransomware operates, requesting the CPU to stop a corresponding process.

The generating of the first OP code frequency waveform may include considering the value of the OP code as a signal to convert the value of the OP code into the frequency domain.

According to another embodiment of the present invention, a method of operating an apparatus that detects whether ransomware operates in a CPU may include receiving an OP code currently being executed in the CPU, converting a value of the OP code into a frequency domain, and analyzing a first value corresponding to the frequency domain to determine whether ransomware operates.

The determining may include comparing a second value, which is a value obtained by converting the OP code corresponding to a ransomware encryption algorithm into the frequency domain with the first value to determine whether ransomware operates.

According to an exemplary embodiment of the present invention, ransomware may be determined in real time or at the initial stage of encryption by determining whether ransomware operates by performing a frequency analysis operation on an OP code generated in a CPU calculation process.

### BRIEF DESCRIPTION OF THE DRAWINGS

FIG. 1 is a diagram illustrating a relationship between a ransomware detection apparatus and a peripheral apparatus according to an exemplary embodiment of the present invention.

FIG. 2 is a diagram showing an example of a round iteration code for an encryption algorithm.

FIG. 3 is a diagram showing a signal of a value of an OP code.

FIG. 4 shows a waveform obtained by converting a signal waveform of FIG. 3 into a frequency domain.

FIG. 5 is a block diagram specifically illustrating the ransomware detection apparatus 100 according to an exemplary embodiment of the present invention.

FIG. 6 is a flowchart showing a ransomware detection method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

The ransomware detection apparatus according to an exemplary embodiment of the present invention may detect ransomware by analyzing a CPU calculation characteristic generated in a data encryption process of software and recognizing encryption in real time or at the initial stage of encryption. The biggest characteristic when ransomware operates in a computer system is that ransomware performs an encryption process repeatedly. The ransomware detection apparatus and method according to an exemplary embodiment of the present invention uses the encryption characteristic of ransomware (that is, repetition of the encryption process), which will be described in detail.

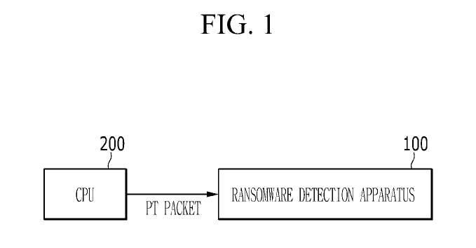

FIG. 1 is a diagram illustrating a relationship between a ransomware detection apparatus 100 and a peripheral apparatus according to an exemplary embodiment of the present invention.

A CPU 200 is a central processing unit in a computer system. The CPU 200 executes various instructions stored in a memory (not shown). In general, the CPU 200 provides a processor tracer (PT) packet. The PT packet provides information capable of decoding an operation code (hereinafter referred to as the ‘OP code’).

The ransomware detection apparatus 100 determines whether ransomware operates using the PT packet provided from the CPU 200. The ransomware detection apparatus 100 detects ransomware using the OP code after decoding the PT packet into the OP code. More specifically, the ransomware detection apparatus 100 determines whether encryption is being performed using a frequency characteristic on the OP code of an encryption algorithm used in ransomware and detects ransomware based on determination.

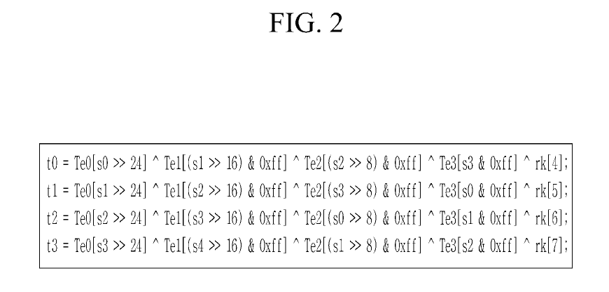

FIG. 2 is a diagram showing an example of a round iteration code for an encryption algorithm. For convenience of explanation, the encryption algorithm of FIG. 2 represents an AES (Advance Encryption Standard) 128 algorithm that is frequently used in ransomware, but other encryption algorithms (TEA, RC4, etc.) used in ransomware may also be applied to the present invention.

The AES 128 algorithm repeats the code shown in FIG. 2 10 times (i.e., round iteration of 10 times is used), and performs encryption on a 128-bit block. Also, AES 192 uses round iteration of 12 times and AES 256 uses round iteration of 14 times. The ransomware detection apparatus 100 according to an exemplary embodiment of the present invention considers a value of an OP code generated, as a signal, while the encryption algorithm is repeatedly performed to conduct a procedure.

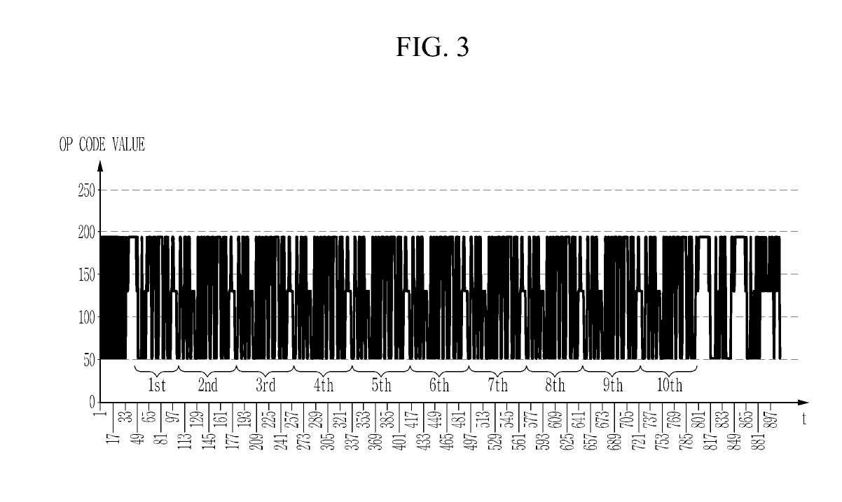

FIG. 3 is a diagram showing a signal of a value of an OP code. That is, FIG. 3 shows that the value of the OP code generated when an encryption algorithm of FIG. 2 is repeatedly performed 10 times is considered as a signal.

Table 1 below is a diagram of OP codes.

TABLE 1

| OP code(decimal) | Instruction |
|---|---|
| 403 | mov rdi, rsp |
| 67 | call 0x7f6fce38d9b0 |
| 639 | push rbp |
| 403 | mov rbp, rsp |
| 639 | push r15 |
| 639 | push r14 |
| 639 | push r13 |
| 639 | push r12 |
| 403 | mov r12, rdi |
| 639 | push rbx |
| 773 | sub rsp, 0x38 |
| 659 | rdtsc |
| 745 | shl rdx, 0x20 |
| 403 | mov eax, eax |
| 466 | or rax, rdx |
| 367 | lea rdx, ptr [rip + 0x22449a] |
| 403 | mov qword ptr [rip + 0x224283], rax |
| 403 | mov rax, qword ptr [rip + 0x22448c] |
| 403 | mov r14, rdx |
| 773 | sub r14, qword ptr [rip + 0x224612] |
| 403 | mov qword ptr [rip + 0x224ff3], rdx |
| 787 | test rax, rax |
| 403 | mov qword ptr [rip + 0x224fd9], r14 |
| 310 | jz 0x7f6fce38da92 |
| 367 | lea rcx, ptr [rip + 0x224634] |
| 403 | mov r9, 0x3800003d8 |
| 403 | mov r8, 0x37ffffb78 |
| 403 | mov esi, 0x6fffffff |
| 403 | mov r11d, 0x6ffffdff |

As shown in Table 1, the OP code may be expressed as a decimal number, and this OP code may be considered as one signal. When the decimal number which is the value of the OP code is considered as a signal value, the value of the OP code for the encryption algorithm of FIG. 2 may be converted into a signal waveform shown in FIG. 3. Since ransomware performs the encryption algorithm repeatedly, as shown in FIG. 3, the signal waveform of the OP code value has periodicity.

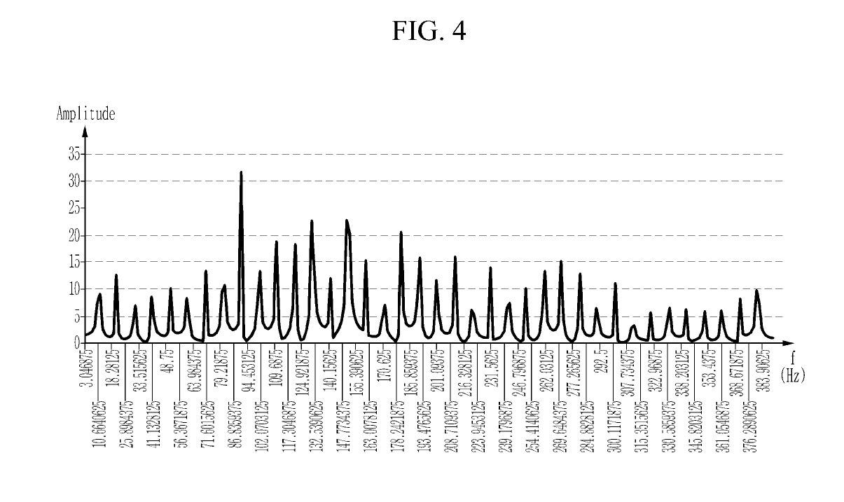

FIG. 4 shows a waveform obtained by converting a signal waveform of FIG. 3 into a frequency domain. That is, FIG. 4 shows that FFT (Fast Fourier Transform) is performed on the signal waveform of FIG. 3. Meanwhile, a FFT sampling size is 512 points in FIG. 4.

As shown in FIG. 4, the frequency transformed waveform has a periodic function frequency characteristic with high amplitude at a multiple of a basic frequency (the number of iterations of an encryption algorithm 10, 10 Hz).

The ransomware detection apparatus 100 according to an exemplary embodiment of the present invention detects whether it is ransomware using a characteristic of an OP code (i.e., a frequency characteristic of the OP code) in an encryption algorithm described in FIGS. 2 to 4.

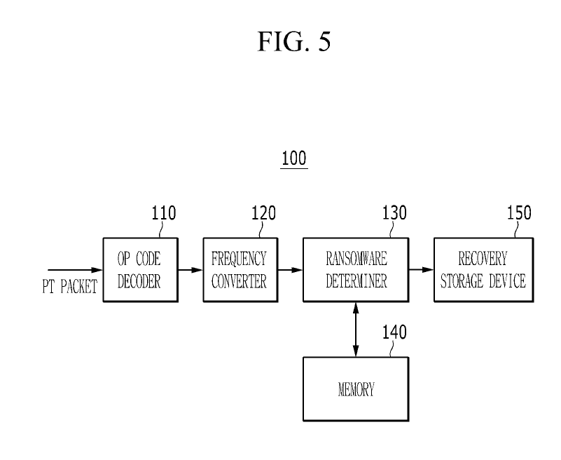

FIG. 5 is a block diagram specifically illustrating the ransomware detection apparatus 100 according to an exemplary embodiment of the present invention.

As shown in FIG. 5, the ransomware detection apparatus 100 according to an exemplary embodiment of the present invention includes an OP code decoder 110, a frequency converter 120, a ransomware determiner 130, a memory 140, and a recovery storage device 150.

The OP code decoder 110 receives a PT packet currently being executed from the CPU 200 and performs decoding on the received PT packet into an OP code. A method of decoding the PT packet into the OP code may be understood by one of ordinary skill in the art, and thus a detailed description thereof is omitted.

The frequency converter 120 receives the OP code from the OP code decoder 110 and performs conversion into a frequency domain by considering a value of the OP code as single signal. Ransomware repeatedly performs an encryption algorithm and thus the value of the OP code corresponding to the encryption algorithm has a periodic characteristic. For example, the value of the OP code for the AES 128 algorithm has a signal waveform as shown in FIG. 3, and the frequency converter 120 may obtain a waveform converted into the frequency domain as shown in FIG. 4. Meanwhile, the frequency converter 120 may perform frequency conversion using a FFT. Hereinafter, a value converted into the frequency domain by the frequency converter 120 is referred to as an ‘OP code frequency waveform’.

The memory 140 previously stores an OP code frequency waveform corresponding to an encryption algorithm (for example, the AES 128 algorithm) used in a ransomware operation. That is, the memory 140 stores the frequency waveform as shown in FIG. 4.

The ransomware determiner 130 receives an input of the OP code frequency waveform from the frequency converter 120. The ransomware determiner 130 determine whether ransomware operates by comparing the OP code frequency waveform received from the frequency converter 120 with the OP code frequency waveform previously stored in the memory 140. In this regard, the ransomware determiner 130 may compare main frequencies between two OP code frequency waveforms (the OP code frequency waveform received from the frequency converter 120 and the OP code frequency waveform previously stored in the memory 140) and calculate a correlation coefficient between the two OP code frequency waveforms. The ransomware determiner 130 may calculate a degree of similarity through the compared main frequency and the calculated correlation coefficient and determine that ransomware currently operates when the degree of similarity exceeds a predetermined reference value. Then, the ransomware determiner 130 may determine that ransomware does not currently operate when the calculated degree of similarity is below the predetermined reference value.

Meanwhile, when the ransomware determiner 130 determines that ransomware currently operates, the ransomware determiner 130 may copy a code currently being executed in a memory (not shown) connected to the CPU 200 and stores the copied code in the recovery storage device 150. That is, the recovery storage device 150 stores the code related to the currently operating ransomware. A user may extract an encryption key by analyzing the code stored in the recovery storage device 150 and recover files infected by Ransomware using the extracted encryption key. The recovery storage device 150 may be implemented as nonvolatile memory. Then, when the ransomware determiner 130 determines that ransomware currently operates, the ransomware determiner 130 may request the CPU 200 to stop a corresponding process.

As described above, the ransomware detection apparatus 100 according to an exemplary embodiment of the present invention may determine whether ransomware operates by frequency-analyzing an OP code generated in a CPU calculation process, thereby determining ransomware in real time or at the initial stage of encryption.

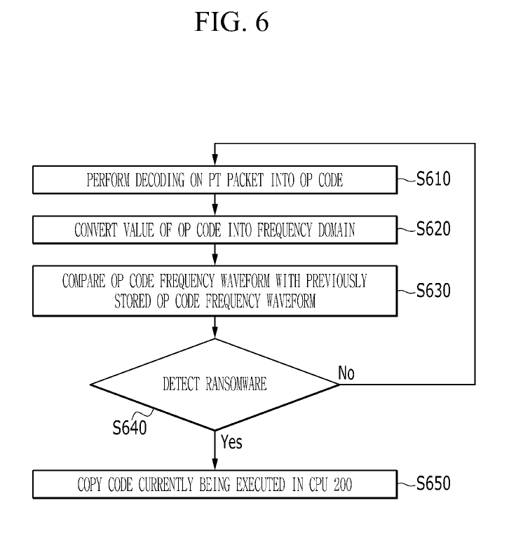

FIG. 6 is a flowchart showing a ransomware detection method according to an exemplary embodiment of the present invention.

The ransomware detection apparatus 100 receives a PT packet currently being executed from the CPU 200 and decodes the received PT packet into an OP code (S610). That is, the OP code decoder 110 decodes the PT packet received from the CPU 200 into the OP code.

The ransomware detection apparatus 100 considers the OP code as a signal and converts a value of the OP code into a frequency domain (S620). The OP code has a time sequentially input value, and thus the OP code may be considered as the signal. The frequency converter 120 converts the value of the OP code considered as the signal into a frequency waveform (an OP code frequency waveform). For example, in the case of the AES 128 algorithm, the frequency converter 120 converts a signal in a time domain shown in FIG. 3 into the signal in the frequency domain shown in FIG. 4.

The ransomware detection apparatus 100 compares the OP code frequency waveform generated in step S620 with a previously stored OP code frequency waveform (S630). The OP code frequency waveform previously stored in the memory 140 is an OP code frequency waveform corresponding to an encryption algorithm used in a ransomware operation. That is, the ransomware determiner 130 may compare main frequencies between the two OP code frequency waveforms, calculate a correlation coefficient between the two OP code frequency waveforms, and calculate a degree of similarity of the two OP code frequency waveforms. If the calculated degree of similarity exceeds a predetermined reference value, the ransomware determiner 130 determines that ransomware currently operates.

If it is determined that a result of comparison in step S630 is ransomware, the ransomware detection apparatus 100 copies and stores the code currently being executed in the CPU 200 (S640 and S650). That is, when the ransomware determiner 130 determines that ransomware operates, the ransomware determiner 130 reads and copies code currently being executed in a memory (not shown) connected to the CPU 200, and stores the copied code in the recovery storage device 150. Then, when the ransomware detection apparatus 100 determines that the ransomware operates, the ransomware detection apparatus 100 requests the CPU 200 to stop a corresponding process.

If it is determined that the result of comparison in step S630 is not ransomware, the ransomware detection apparatus 100 returns back to step S610 (S640 and S610).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A ransomware detection apparatus comprising:
a frequency converter receiving an OP code currently being executed in a CPU and converting a value of the OP code into a frequency domain to generate a first OP code frequency waveform,
a memory storing a second OP code frequency waveform, which is a value obtained by converting the OP code corresponding to a ransomware encryption algorithm into a frequency domain, and
a ransomware determiner comparing the first OP code frequency waveform with the second OP code frequency waveform to determine whether ransomware operates

2. The ransomware detection apparatus of claim 1, further comprising:
an OP code decoder receiving a processor tracer packet corresponding to a calculation code from the CPU and decoding the processor trace packet into the calculation code, and then outputting the decoded calculation code to the frequency converter.

3. The ransomware detection apparatus of claim 1, wherein:
the ransomware determiner calculates a degree of similarity between the first OP code frequency waveform and the second OP code frequency waveform and determines that ransomware operates when the degree of similarity exceeds a predetermined reference value.

4. The ransomware detection apparatus of claim 3, wherein:
the ransomware determiner compares main frequencies between the first OP code frequency waveform and the second OP code frequency waveform and calculates a correlation coefficient to calculate the degree of similarity.

5. The ransomware detection apparatus of claim 1, wherein:
when the ransomware determiner determines that ransomware operates, the ransomware determiner stores the code currently being executed in the CPU in a recovery storage device.

6. The ransomware detection apparatus of claim 1, wherein:
when the ransomware determiner determines that ransomware operates, the ransomware determiner requests the CPU to stop a corresponding process.

7. The ransomware detection apparatus of claim 1, wherein:
the frequency converter performs an FFT (Fast Fourier Transform) on the value of the OP code to generate the first OP code frequency waveform.

8. The ransomware detection apparatus of claim 1, wherein:
the value of the OP code is a decimal number.

9. A method of operating a ransomware detection apparatus that detects whether ransomware operates in a computer system comprising a CPU, the method comprising:
receiving a PT (processor tracer) packet currently being executed from the CPU,
decoding the PT packet into an OP code (operation code),
converting a value of the OP code into a frequency domain to generate a first OP code frequency waveform,
storing a second OP code frequency waveform, which is a value obtained by converting the OP code corresponding to a ransomware encryption algorithm into a frequency domain, and
comparing the first OP code frequency waveform with the second OP code frequency waveform to determine whether ransomware operates.

10. The method of claim 9, wherein:
the determining comprises,
calculating a degree of similarity between the first OP code frequency waveform and the second OP code frequency waveform, and
determining that ransomware operates through the degree of similarity.

11. The method of claim 9, further comprising:
when it is determined in the determining that ransomware operates, storing the code currently being executed in the CPU.

12. The method of claim 9, further comprising:
when it is determined in the determining that ransomware operates, requesting the CPU to stop a corresponding process.

13. The method of claim 9, wherein:
the generating of the first OP code frequency waveform comprises considering the value of the OP code as a signal to convert the value of the OP code into the frequency domain.

14. A method of operating an apparatus that detects whether ransomware operates in a CPU, the method comprising:
receiving an OP code currently being executed in the CPU,
converting a value of the OP code into a frequency domain, and
analyzing a first value corresponding to the frequency domain to determine whether ransomware operates.

15. The method of claim 14, wherein:
the determining comprises comparing a second value, which is a value obtained by converting the OP code corresponding to a ransomware encryption algorithm into the frequency domain with the first value to determine whether ransomware operates.
